(19) United States
(12) Patent Application Publication
(10) Pub. No.: US 2025/0321615 A1
(43) Pub. Date: Oct. 16, 2025

(54) ATTACHABLE AND DETACHABLE ALUMINUM WATER-RESISTANT SMART SAFETY DEVICE ENCLOSURE WITH MULTIFUNCTIONAL FEATURES

(71) Applicants: Sanjay Gupta, Saint Paul, MN (US); Zupei Tan, Shenzhen City (CN)

(72) Inventors: Sanjay Gupta, Saint Paul, MN (US); Zupei Tan, Shenzhen City (CN)

(21) Appl. No.: 18/631,252

(22) Filed: Apr. 10, 2024

(51) Int. Cl. G06F 1/16; A45B 3/04; A45B 3/08; A45B 9/02

(52) U.S. Cl. CPC G06F 1/1626; A45B 3/04; A45B 9/02; G06F 1/1656; G06F 1/1694; A45B 3/08

(57) ABSTRACT

This invention relates to a multifunctional smart safety device designed for versatile use in various environments including homes, cars, bicycles, boats, and outdoor activities such as hiking and emergency scenarios. The device incorporates an attachable and detachable durable aluminum enclosure, providing robust protection against dust and water while maintaining lightweight characteristics, ensuring functionality in diverse weather conditions. Key features include a flashlight, NOAA and AM/FM radio, a two-way radio for communication in remote areas, a power bank with a replaceable battery, solar charging, multiple functional LEDs, an SOS flashlight beacon, an ultrasonic dog whistle, a micro-SD card MP3 slot, a digital media player, a built-in speaker, telescopic antenna, Bluetooth connectivity, bi-directional USB-C, a directional compass, and an LCD screen display. This combination of features provides users with a comprehensive safety tool adaptable to a wide range of emergency and recreational scenarios.

### BACKGROUND OF THE INVENTION

The present invention relates to a multifunctional safety device designed for versatility and reliability in various environments including home, automotive, marine, outdoor, and emergency scenarios. Traditional safety devices often cater to specific use-cases and lack the integration of multiple functionalities in an attachable and detachable, portable, durable format. This invention aims to address these limitations by offering a comprehensive set of features in a single, versatile, user-friendly device.

### SUMMARY OF THE INVENTION

In one aspect of the present invention, this invention relates to a multifunctional smart safety device designed for versatile use in various environments including homes, cars, bicycles, boats, and outdoor activities such as hiking and emergency scenarios.

In another aspect of the present invention, the device incorporates an attachable and detachable durable aluminum enclosure, providing robust protection against dust and water while maintaining lightweight characteristics, ensuring functionality in diverse weather conditions.

In another aspect of the present invention, the key features of the device include, but are not limited to, a flashlight, NOAA and AM/FM radio, a two-way radio, a power bank with a replaceable and/or rechargeable battery, solar charging capabilities, multiple functional LEDs, an SOS flashlight beacon, an ultrasonic dog whistle, a micro-SD card MP3 slot, a digital media player, a built-in speaker and built-in microphone, telescopic antenna, Bluetooth connectivity, bi-directional USB-C, a directional compass, and an LCD screen display.

In another aspect of the present invention, the present invention is directed to a hiking pole grip assembly designed to facilitate ergonomic holding of the hiking pole and featuring an integrated threading mechanism for attaching various hiking aid and/or safety devices and a 15-degree corrective angle to aid in the ease of access to an electronic device's control panel when attached, thereby enhancing user interaction with the device.

This combination of features provides users with a comprehensive safety tool adaptable to a wide range of emergency and recreational scenarios.

These and other features, aspects and advantages of the present invention will become better understood with reference to the following drawings, description, and claims.

### BRIEF DESCRIPTION OF THE DRAWINGS

FIG. 1 is front and side views of a multifunctional smart safety device in accordance with a preferred embodiment of the present invention;

FIG. 2 is rear view of the multifunctional smart safety device of FIG. 1;

FIG. 3 is top view of the multifunctional smart safety device of FIG. 1;

FIG. 4 is bottom view of the multifunctional smart safety device of FIG. 1;

FIG. 5 depicts cross-sectional views of the multifunctional smart safety device of FIG. 1 taken along line A-A;

FIG. 6 is an exploded perspective view of the multifunctional smart safety device of FIG. 1;

FIG. 7 is a rear view of a multifunctional smart safety device in accordance with an alternative embodiment of the present invention;

FIG. 8 is perspective view of the multifunctional smart safety device of FIG. 1 attached to a hiking pole;

FIG. 9 is side view of the multifunctional smart safety device of FIG. 1 attached to a bicycle;

FIG. 10 is perspective view of the multifunctional smart safety device of FIG. 1 attached to a boat;

FIG. 11 is perspective view of the multifunctional smart safety device of FIG. 1 attached to a hiking pole being used by a hiker;

FIG. 12 is an exploded view of a hiking pole grip assembly constructed in accordance with a preferred embodiment of the present invention; and

FIG. 13 is a side and partial cross-sectional view of a hiking pole with the hiking pole grip assembly of FIG. 12.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a multifunctional smart safety device designed for versatile use in various environments including homes, cars, bicycles, boats, and outdoor activities such as hiking and emergency scenarios. In a preferred embodiment, the device incorporates an attachable and detachable durable aluminum enclosure, providing robust protection against dust and water while maintaining lightweight characteristics, ensuring functionality in diverse weather conditions. While an aluminum enclosure is preferred, other suitable enclosure materials may be used as a matter of application-specific design choice without departing from the spirit of the invention.

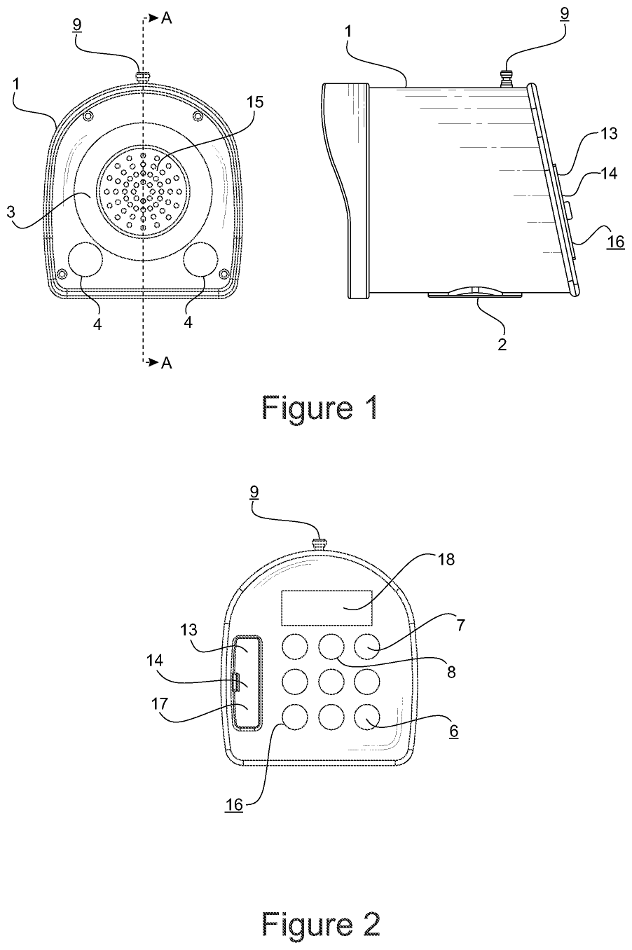

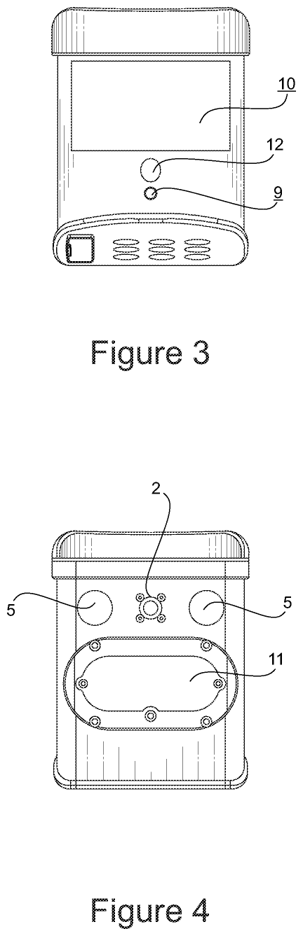

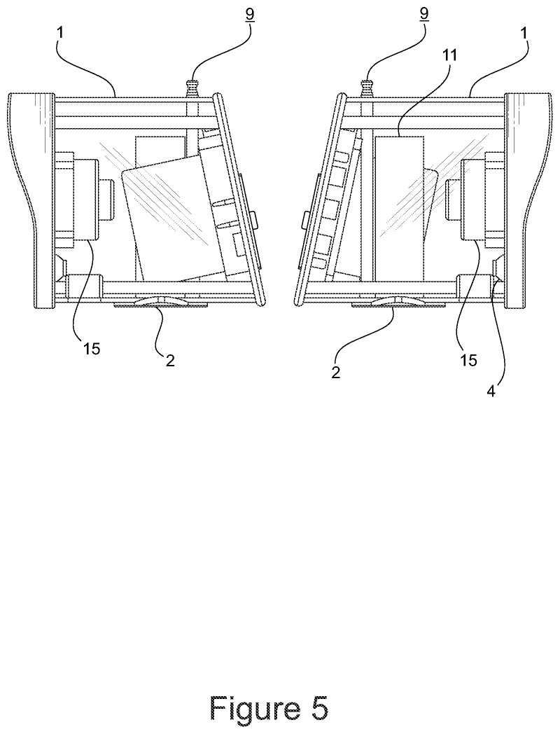

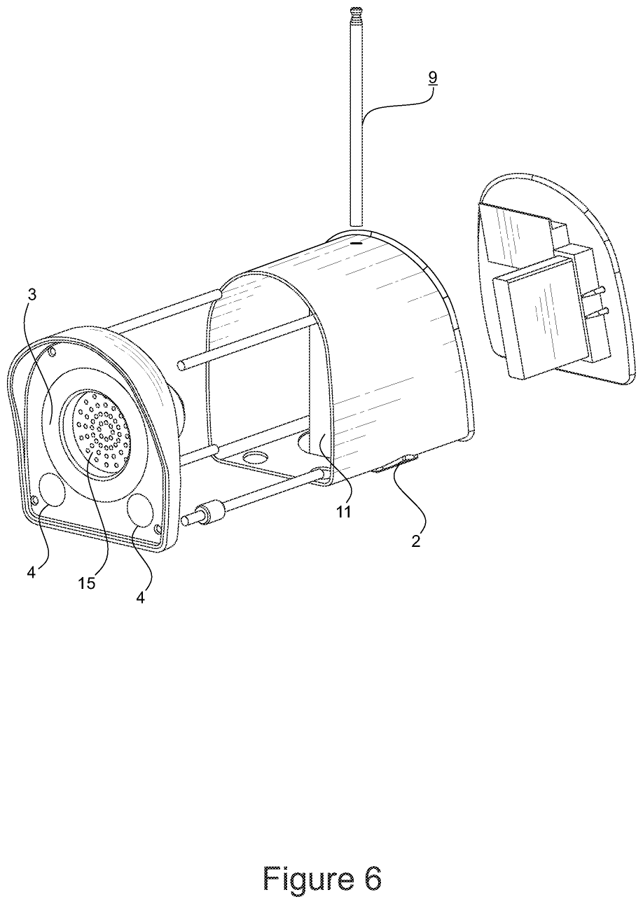

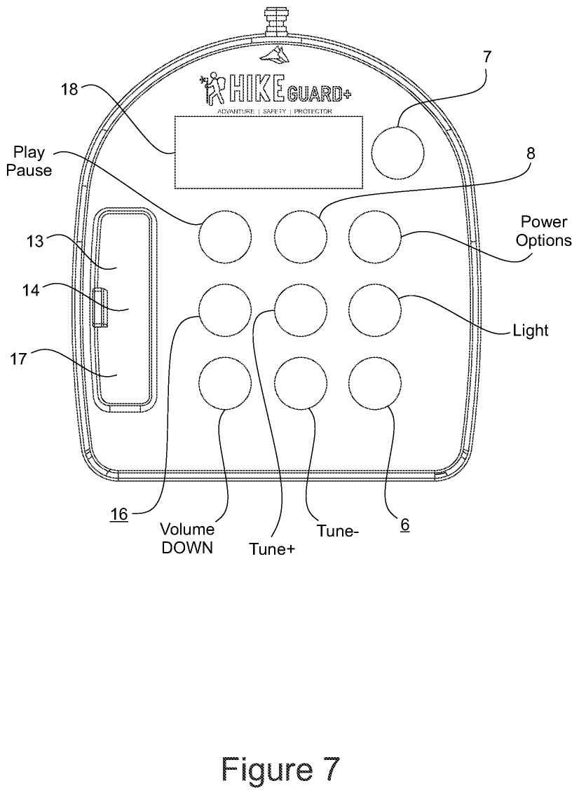

In a preferred embodiment, and as seen in FIGS. 1-8, key features of the device include a flashlight, a National Oceanic and Atmospheric Administration (NOAA) and AM/FM radio, a two-way radio, a power bank with one or more replaceable and/or rechargeable batteries, solar charging capability, multiple functional LEDs, an SOS flashlight beacon, an ultrasonic dog whistle, a micro-SD card MP3 slot, a digital media player, a built-in speaker with microphone, telescopic antenna, Bluetooth connectivity, bi-directional USB-C, a directional compass, and an LCD screen display. This combination of features provides users with a comprehensive safety tool adaptable to a wide range of emergency and recreational scenarios. Other components or devices could also be incorporated into the multifunctional smart safety device of the present invention without departing from the spirit of the invention as a matter of application-specific design choice.

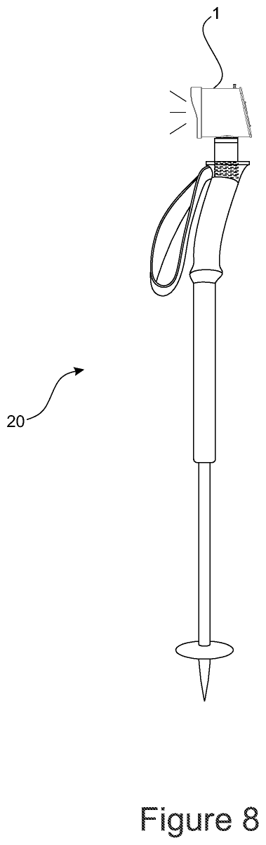

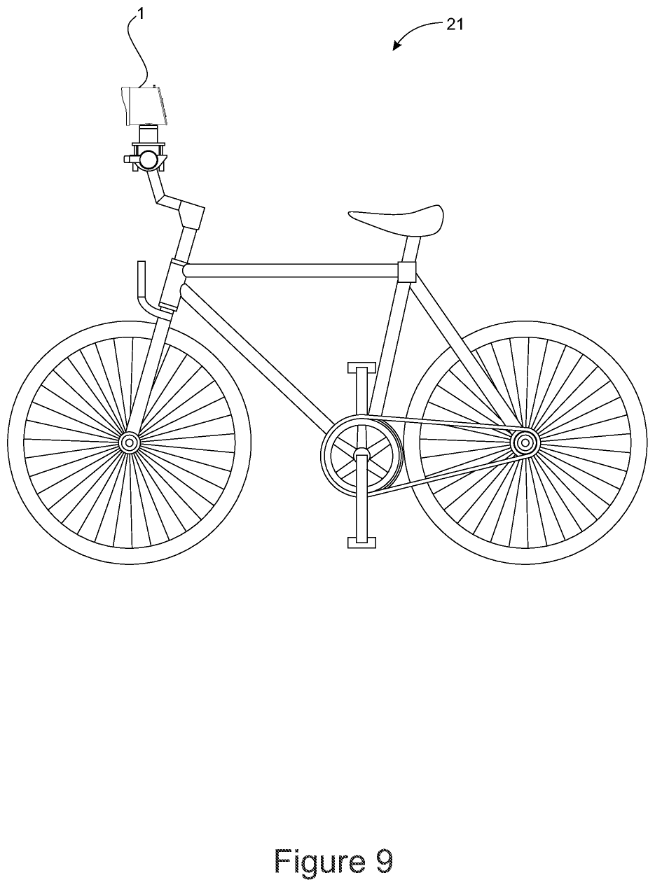

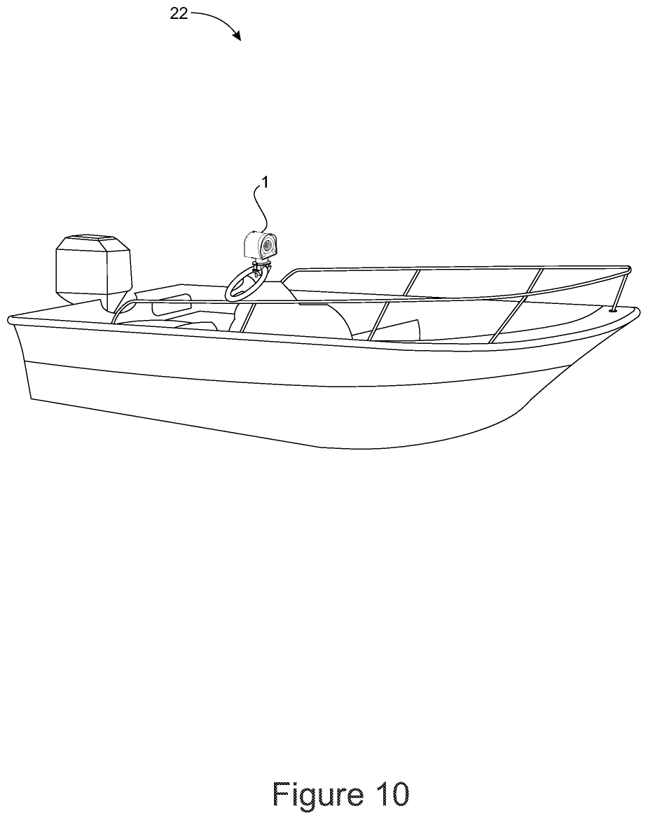

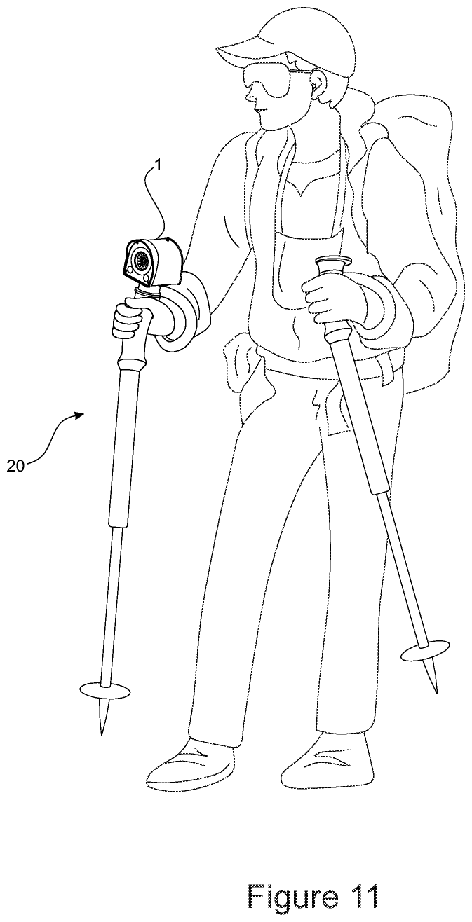

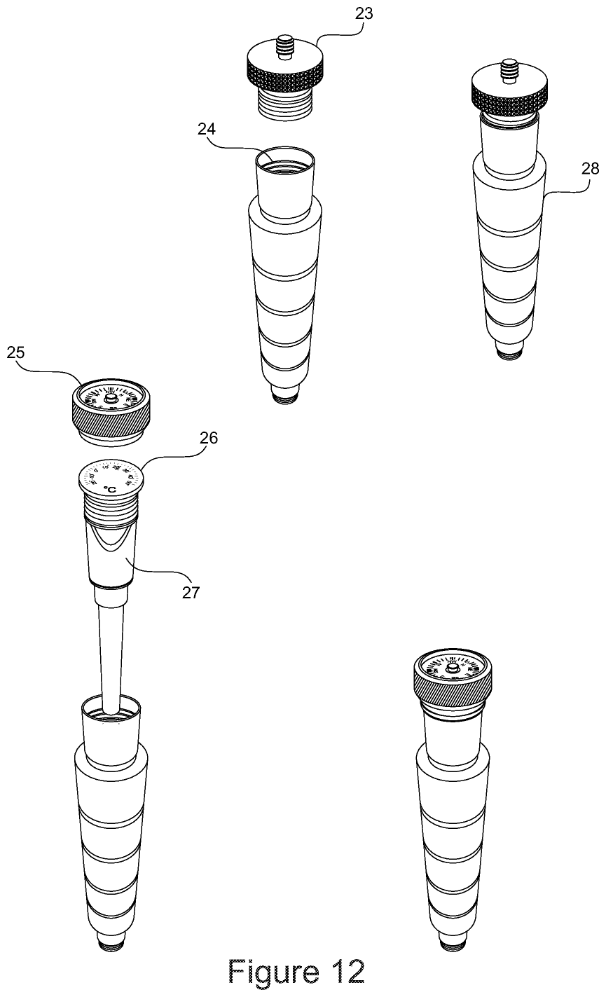

As described in more detail below, and as seen in FIGS. 1-7 hereto, in a preferred embodiment the multifunctional smart safety device of the present invention comprises a water-resistant enclosure made of aluminum (see, e.g., FIG. 1 at 1). As described in more detail below, and as seen in FIGS. 8-13 hereto, in a preferred embodiment the multifunctional smart safety device of the present invention is configured to be attachable and detachable for various applications (see, e.g., FIGS. 8 and 11 for hiking, FIG. 9 for bicycling, and FIG. 10 for boating, by way of example).

The multifunctional smart safety device incorporates many multifunctional features for emergency preparedness, including an emergency weather alert system for severe weather or for civil or other emergencies. For example, as seen in FIGS. 1 and 2 by way of example, in a preferred embodiment the multifunctional smart safety device 1 comprises an array of front LED flashlights 3 for providing illumination during power outages and while navigating low-light areas and in other situations; an SOS flashlight beacon 4 which can provide an alert function for emergency signaling situations; two or more LED lights 5 along the bottom of the enclosure that can be used for reading while camping or engaging in other activities, an ultrasonic high frequency dog whistle 6 for use in emergency situations and to aid in locating the device and its users.

As further seen in FIGS. 1-7, in a preferred embodiment the multifunctional smart safety device 1 can include communication and navigation features including a NOAA radio 7 for weather alerts and other information, an AM/FM radio 8 for receiving audio broadcasts, wherein the two-way radio provides communication capabilities in remote areas where cellular signals may be unavailable. The multifunctional smart safety device 1 can also include a telescopic antenna 9 for high sensitivity reception and a wider and more stable range of search signals, and the device 1 also can include an attachment mechanism 2 so that the device 1 can be attachable and detachable to various locations and implements, such as a hiking pole 20 (FIGS. 8, 11 and 13), a bicycle 22 (FIG. 9), a boat 24 (FIG. 10).

In a preferred embodiment the multifunctional smart safety device 1 includes multiple sustainable power options for prolonged use in emergency situations, including power and charging capabilities such as a power bank with a rechargeable and/or replaceable battery 11 for charging external devices and the ability to power and recharge other devices to maintain communication and power essential equipment and for other functions. One or more solar charging panels 10 can also be integrated into the aluminum enclosure to recharge the power bank.

In a preferred embodiment the multifunctional smart safety device 1 includes a directional guidance compass 12, as well as sound and entertainment features including a Micro-XD SD Card slot 13 for storing and playing media files, and a media player with a built-in speaker 15, Bluetooth receiver/transmitter 16 for wireless communication, and information dissemination, a bi-directional USB C port 17 for data transfer and charging, and an LCD screen display 18 for user interface and information display.

In a preferred embodiment the multifunctional smart safety device enclosure 1 is constructed from high-grade aluminum, offering robustness and lightweight properties. Enclosure 1 also includes an attachment mechanism 2, such as a threaded opening, at the bottom of enclosure 1 to allow the multifunctional smart safety device 1 to attach and detach for different functional uses (as seen, by way of example, in FIGS. 8-13). Enclosure 1 is designed to provide easy access to the internal components, as well as for maintenance and battery replacement. Enclosure 1 is also designed to be water-resistant with sealed seams, ensuring device functionality in diverse weather conditions.

In a preferred embodiment the multifunctional smart safety device comprises numerous multifunctional lighting features. For example, it includes an integrated flashlight 3 with adjustable brightness settings for illumination in low-light situations, enhancing safety during outdoor activities or emergencies. Multiple functional LEDs 3 can be used to indicate various statuses and signals, navigate in dark, and are perfect for reading in camping conditions and outdoor adventures. An SOS flashlight beacon 4 can also be included for emergency signaling.

In a preferred embodiment the multifunctional smart safety device comprises various communication and navigation capabilities as well. For example, the device can include a NOAA radio 7 for accessing weather alerts and emergency broadcasts, which can prove to be essential for receiving updates in emergency weather situations. The device can also include an AM/FM radio 8 for receiving information and entertainment broadcast, allowing users to stay informed during emergencies or recreational activities. The device can also include a two-way radio feature, enabling reliable communication in areas without cellular coverage, essential for outdoor activities and emergency situations. The device can include a telescopic antenna 9 for high sensitivity reception and a wider and more stable range of search signals. In a preferred embodiment the multifunctional smart safety device 1 comprises Bluetooth connectivity 16 for wireless communication with other devices, a directional compass 12 for navigation purposes for users exploring unfamiliar terrain, which can be essential for outdoor activities like hiking and boating.

In a preferred embodiment the multifunctional smart safety device comprises various power and charging capabilities. For example, the device can include a rechargeable power bank 11 with the convenience of replaceable high-capacity batteries that allow for prolonged usage and longevity of the device. The device can also include the added convenience of solar charging 10, allowing users to replenish the battery using solar energy, especially during extended outdoor trips. The device can also include a bi-directional USB-C port 17 for charging the device and other USB-C compatible devices.

In a preferred embodiment the multifunctional smart safety device comprises various sound and entertainment features. For example, the device can include an ultrasonic dog whistle 6 for canine training or deterrent in outdoor activities and in wilderness scenarios to assist search and rescue teams in locating individuals during an emergency. Two small front LEDs 4 can be used as for SOS signaling mode flashlight for emergency situations, which would be visible from a significant distance. The device can also include a micro-XD SD card slot 13, as well as a media player with a built-in speaker 15, supporting various audio formats. The device can connect to internal or external speakers or headphones via Bluetooth 16 or via a headphone jack 14 for private listening. Equipped with a built-in microphone for the two-way radio, enabling clear voice communication, enhances user interaction during two-way radio communications in diverse environments.

In a preferred embodiment the multifunctional smart safety device comprises an integrated display and a built-in user interface. For example, the device can include an LCD screen display 18 to show device status, battery level, radio channels, navigation details and other information, and provide a user-friendly interface with buttons and dials for easy operation.

The multifunctional smart safety device 1 of the present invention has many applications and uses, as seen by way of example in FIGS. 8-13. For example, the device is ideal for use in homes, cars, bicycles, and boats for safety and entertainment, and will provide a valuable tool for outdoor activities like hiking, providing navigation, illumination, and emergency signaling capabilities.

As seen in FIGS. 8 and 11-13, one application of the multifunctional smart safety device 1 of the present invention includes use in connection with a hiking pole 20. In this application, a hiking pole grip assembly comprising a grip portion 28 designed to facilitate ergonomic holding of the pole 20, wherein the grip portion 28 comprises an integrated threading mechanism 24, and wherein the assembly also comprises and an adapter 23 that is selectively engageable with the integrated threading mechanism 24, and wherein the adapter 23 is configured for detachable connection with an electronic device, such as the multifunctional smart safety device 1 of the present invention, to facilitate the electronic device's secure attachment to and detachment from the hiking pole 20.

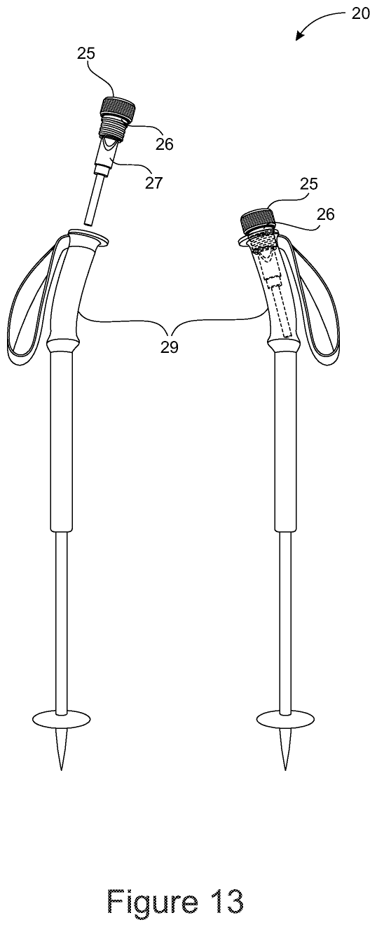

The assembly also comprises a multifunctional cap 25 that is compatible with the integrated threading mechanism 24 for use when the electronic device is not attached. In a preferred embodiment, the multifunctional cap 25 comprises a compass visibly integrated into the cap's upper surface for directional navigation, and a temperature display 26 embedded within the cap for environmental awareness. In a preferred embodiment, the assembly also comprises an emergency whistle 27 incorporated into the cap, intended for use in distress situations, wherein the integration of the compass, temperature display, and emergency whistle into the multifunctional cap provides a hiker with essential survival tools in the absence of the electronic device, enhancing the utility and safety features of the hiking pole. In a preferred embodiment, the grip portion is designed to facilitate ergonomic holding (see FIG. 13 by way of example) and includes an integrated threading mechanism and a 15-degree corrective angle to aid in the ease of access to the electronic device's control panel when attached, thereby enhancing user interaction with the device.

In a preferred embodiment the multifunctional smart safety device 1 of the present invention meets or exceeds relevant safety and environmental standards. It is designed with user safety in mind, featuring water-resistant and durable construction. The device is ideal for home emergency kits, vehicles, outdoor recreational activities, and situations where a combination of these tools could be lifesaving or highly beneficial. Its attachable and detachable multifunctional feature 2 makes it an indispensable tool for a wide range of scenarios.

The multifunctional smart safety device 1 of the present invention stands as a versatile, comprehensive, and user-friendly essential tool that addresses the need for a multi-functional safety device for various scenarios, providing reliability, entertainment, and safety features in a single, lightweight, and highly portable unit. Its multifunctionality and durable design make it a valuable addition to any home, vehicle, or outdoor adventure kit. The integration of multiple features into a single, portable unit makes it an ideal choice for preparedness and convenience.

It should be understood, of course, that the foregoing relates to exemplary embodiments of the invention and that modifications may be made without departing from the spirit and scope of the invention as set forth in the following claims.

What is claimed is:

1. A smart safety device comprising:
an aluminum water-resistant enclosure comprising an attachment mechanism for removably attaching the device to another object;
an array of LED lights with adjustable brightness levels;
an SOS flashlight beacon;
an NOAA radio;
an AM/FM radio;
a two-way radio;
a telescopic antenna;
a power bank comprising a rechargeable replaceable batteries;
a directional guidance compass;
a high-frequency dog whistle;
a Micro-XD SD Card slot;
a media player with a built-in speaker and built-in microphone;
a bluetooth port for wireless communication;
a Bi-directional USB C port; and
an LCD screen display.

2. The smart safety device of claim 1, further comprising a solar charging panel integrated into the enclosure for harnessing solar energy to charge the power bank.

3. The smart safety device of claim 1, wherein the LCD screen display is configured to display system statuses and operational feedback, improving user interaction and accessibility.

4. The smart safety device of claim 1, further comprising an emergency weather alert system that is capable of receiving weather alerts and civil emergency notifications, and a two-way radio feature to facilitate direct communication between users in environments where cellular signals are unavailable, thereby enhancing the device's utility in outdoor and emergency contexts.

5. The smart safety device of claim 1, wherein the attachment mechanism allows for use in various multifunctional settings, including home, car, biking, boat, hiking, emergency preparedness and other scenarios.

6. The smart safety device of claim 1, wherein the power bank comprises a user-replaceable batteries for extended device lifespan and for powering the device and designed to provide continuous power supply to USB-compatible devices for extended periods during emergencies.

7. The smart safety device of claim 1, wherein the bi-directional USB C port can both input and output electrical power and data.

8. The smart safety device of claim 1, wherein the Bluetooth port allows for wireless connection to external devices for music streaming and remote control.

9. The smart safety device of claim 1, wherein the water-resistant enclosure is IPX3 to IPX7 rated, providing protection against dust and immersion in water.

10. The smart safety device of claim 1, further comprising safety and compliance features including an emergency alert button and compliance with relevant safety standards and protocols for emergency communication.

11. The smart safety device of claim 1, wherein the array of LED lights includes adjustable brightness levels and strobe modes for various use cases.

12. The smart safety device of claim 1, wherein the SOS beacon includes multiple flashing patterns to convey different emergency messages.

13. A hiking pole grip assembly comprising:
a grip portion designed to facilitate ergonomic holding of the hiking pole, said grip portion featuring an integrated threading mechanism;
an adapter selectively engageable with said integrated threading mechanism, wherein said adapter is configured for detachable connection with an electronic device, facilitating the electronic device's secure attachment to and detachment from the hiking pole;
a multifunctional cap compatible with said integrated threading mechanism for use when the electronic device is not attached, said multifunctional cap comprising:
a compass visibly integrated into the cap's upper surface;
a temperature display embedded within the cap; and
an emergency whistle incorporated into the cap.

14. The hiking pole grip assembly of claim 13, further comprising a grip portion designed to facilitate ergonomic holding, said grip portion featuring an integrated threading mechanism and a 15-degree corrective angle to aid in the ease of access to an electronic device's control panel when attached, thereby enhancing user interaction with the device.

15. The hiking pole grip assembly of claim 13, wherein an adapter is selectively engageable with said integrated threading mechanism, configured for detachable connection with an electronic device, facilitating the secure attachment to and detachment from the hiking pole.

16. The hiking pole grip assembly of claim 13, further comprising a grip portion, oriented to project light downwards at an angle, said grip portion featuring an integrated threading mechanism and a 15-degree corrective angle preventing the light from shining directly into the eyes of a person standing in front of the user, thereby enhancing safety during use in dark conditions.
